(19) United States
(12) Patent Application Publication
(10) Pub. No.: US 2008/0158152 A1
(43) Pub. Date: Jul. 3, 2008

(54) CURSOR JUMP CONTROL WITH A TOUCHPAD

(75) Inventor: Joseph R. Parker, Hillsborough, NC (US)

Correspondence Address: Driggs, Hogg, Daugherty & Del Zoppo Co., L.P.A., 38500 CHARDON ROAD, DEPT. LEN, WILLOUGHBY HILLS, OH, 44094, US

(73) Assignee: LENOVO (SINGAPORE) PTE. LTD., New Tech Park (SI)

(21) Appl. No.: 11/616,437

(22) Filed: Dec. 27, 2006

(51) Int. Cl. G06F 3/033

(52) U.S. Cl. 345/157

(57) ABSTRACT

A method and structure for positioning the cursor on a computer which uses a touch pad for cursor control wherein a cursor jumps from one point to another point on the screen without being in between, and wherein a cursor is displayed and a touchpad is connected to the screen, comprising the steps of: associating a coordinate system on the touchpad with a coordinate system on said screen to generate locations on the screen corresponding to given locations on the touchpad; causing the setting of time and pressure on the touchpad for a valid response; causing the determination of an average point with reference to a finger on the touchpad and, thus, a point on the screen for movement of the cursor to the point responsive to the set pressure and time on a given location on the touchpad.

### FIELD OF THE INVENTION

This invention relates generally to an easy-to-use method and structure for quickly positioning the mouse cursor on a personal computer and, more particularly, to a touch-pad device for mouse control which can quickly and easily move the cursor without the cursor having to be between the original location and the new moved-to location.

### BACKGROUND OF THE INVENTION

Many laptop computers are now being shipped with touchpad devices along with wide-screen or large resolution displays. To move the mouse cursor from one corner of the screen to another, or indeed from one remote location to another, requires multiple finger strokes across the touchpad surface. The underlying assumption behind these types of computers, such as the ThinkPad T60p by Lenovo, is that there is a touchpad device on the system which receives input from the user based on user settable pressure and movement applied to its surface. The input from the user is translated to movement and positioning of the mouse cursor. The touchpad device described above is a standard touchpad, such as the device which can be found on a Lenovo ThinkPad T60p computer, which is incorporated herein by reference. Configuring the amount of pressure required to activate the touchpad device is already a common configuration for standard touchpad devices of the type disclosed in the T60p ThinkPad. Typically, the pressure settings are “low”, “medium” and “high”, although other schemes can be used. The supporting device driver software for the touchpad device provides a graphical user interface which allows the user to set the pressure sensitivity of the touchpad device.

### SUMMARY OF THE INVENTION

The basis for this application is an easier-to-use method and computer system for quickly positioning the mouse cursor on the screen of a personal computer which uses a touch pad device for mouse control. A method of and structure for causing a mouse cursor in a computer system to jump from one point on a screen to another point on said screen optimally without being in between on the screen, and wherein a mouse cursor is displayed on said screen, and a touchpad is operatively connected to said screen, comprises the steps of: associating a coordinate system on said touchpad with a coordinate system on said screen to generate locations on said screen corresponding to given locations on said touchpad; setting of pressure for a valid response from said touchpad to said screen at each coordinate location on the touchpad; setting the time for a valid response from said touchpad to said screen; and determining a single point with reference to a finger on said touchpad and, thus, an associated point on said screen for the movement of the mouse cursor to said associated point responsive to said set pressure and said set time on a given location on said touchpad.

### BRIEF DESCRIPTION OF THE DRAWINGS

FIG. 1 is a diagrammatic drawing of a computer that is satisfactory for practicing this invention;

FIG. 2 is a compact disc (CD) suitable for receiving the program of this invention; and

FIG. 3 is a flow diagram of the steps of this invention.

### DETAILED DESCRIPTION OF THE PREFERRED EMBODIMENT(S)

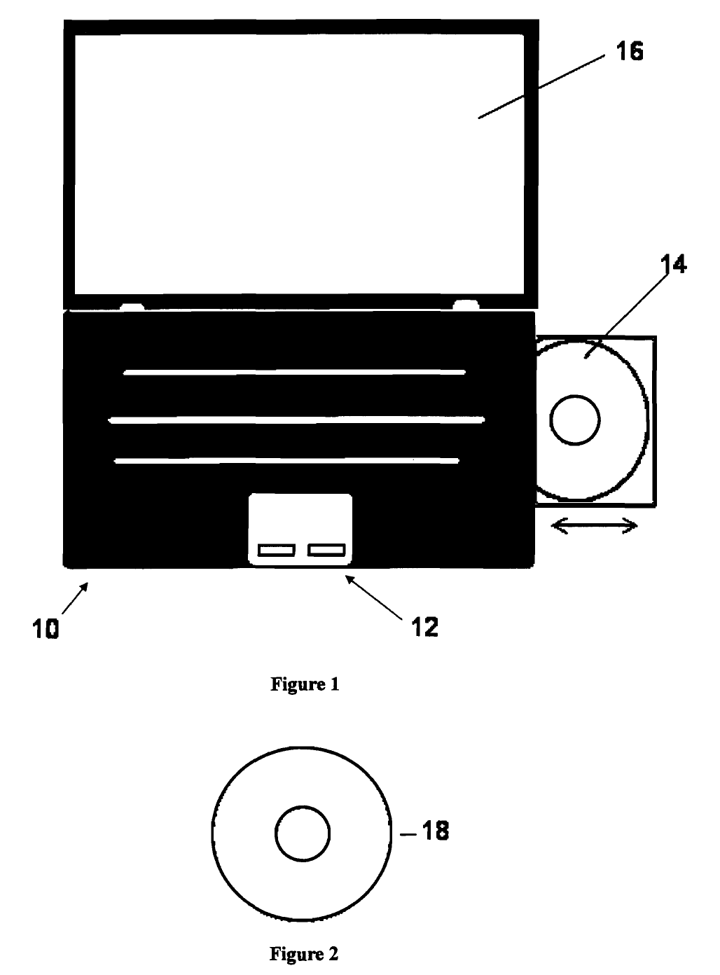

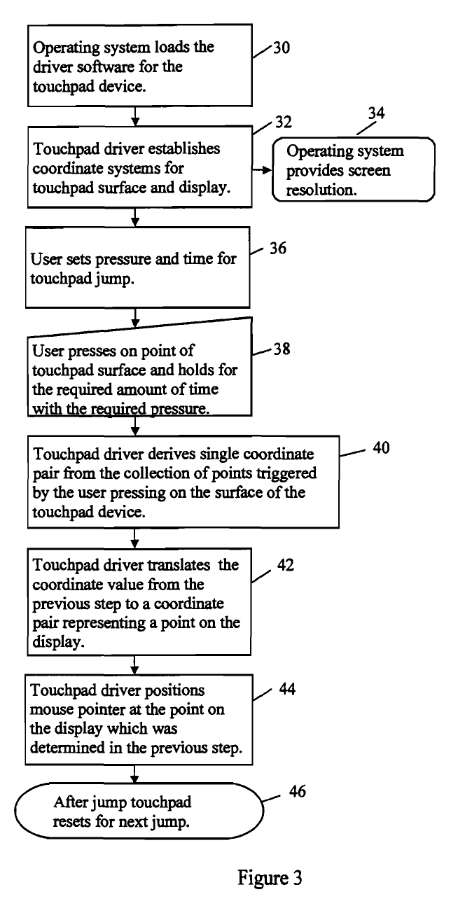

Referring now to the drawings, and for the present to FIG. 1, a computer 10 having a touchpad 12 is shown. The computer 10 with the touch pad 12, has a disc receiving tray 14 and screen 16 which can be and preferably is a ThinkPad T60p. A disc 18 having a program thereon (which will be described presently) is shown in FIG. 2, which disc 18 is inserted into the computer 10. The software described here preferably is a part of the device driver for the touchpad device 12. It can be delivered in any of the standard delivery methods, such as on CD 18, pre-installed on the computer's hard disk drive, or electronically over a network (e.g. a computer company's support web site). The software can be installed on the computer and would reside with the computer's operating system on the local hard disk. The functionality of the program is provided to the computer operating system (not shown) by device driver software of the touchpad 12 device. A flow diagram of the program is shown in FIG. 3. The device driver software will also provide an x, y coordinate representation of the touchpad surface, and will determine a similar x, y coordinate representation of the display screen 16 based on information gathered from the operating system, the information and gathering thereof being conventional prior art.

To implement this program, the touchpad device 12 driver software would associate a coordinate (x, y) system on the surface of the screen 16 to the surface of the touchpad device 12. The device driver software for the touchpad device will map the touchpad surface to the current screen resolution each time a “jump” is triggered. This allows for the user to alter their screen resolution at any time without affecting the accuracy of the “jump”. For instance, the upper left corner of the touchpad surface would be referred to as (0, 0). The lower right corner would be referred to as (100, 100). The x, y coordinates of the touchpad 12 surface could then be considered percentage representations of the display screen's resolution. For instance, if the display is 1280 pixels by 1024 pixels, then a point at 50, 50 (center of the touchpad 12) on the surface of the touchpad would translate to 640 pixels, 512 pixels on the display screen 16. In this case, the code is the circuitry contained in the computer 10.

Due to the size of the human finger and the resolution of the touchpad device, when a user presses on a point of the touchpad surface, there will be multiple points which register with the touchpad device. These points will roughly represent a circle. The device driver software of the touchpad device optimally takes the minimum and maximum coordinate combinations and generates an average value for each coordinate. For example, if the minimum set of coordinates were (4, 3) and the maximum set of coordinates were (7, 4), then the resulting point would be (5.5, 3.5). This point can then be converted to a point within the resolution of the display device.

When the user presses on a point of the touchpad surface, he/she will have to apply a certain amount of pressure and hold that pressure for a certain amount of time before the touchpad driver will interpret the action as a request to jump the mouse pointer to a new position. Since this pressure is already a function of the touchpad 12, this pressure can be the pressure needed to actuate the cursor. Preferably, however, the level of pressure required and the hold time can be configurable settings which the user can customize through the operating system's interface to the driver software of the touchpad device 12. The end user will be provided a configuration utility which can be accessed by the normal means for the operating system he/she is using (e.g. in the Control Panel for Microsoft operating systems). This configuration utility will allow the end user to specify the amount of pressure required for the touchpad device to register it as a request for a jump. The user will also be able to specify the duration for which the pressure must be held in order to trigger the jump. Normally, the user will want to set the pressure to a “high” (as described above with respect to the level on ThinkPad T60p) and the time at about one second; however, a user is free to choose any selectable pressure or time. It is to be understood that these selected pressures and times are minimum pressures and times, requiring the finger to provide at least the pressure and time selected. This will cause the mouse cursor to jump from its original position to the desired position optimally without being in any position in between. Also, once the cursor has jumped, the program will reset itself for the next jump.

Turning now specifically to FIG. 3, first the operating system loads the driver software containing the invention as shown in box 30. Following this loading, the touchpad driver establishes coordinate systems for the touchpad 12 surface and display screen 16 as shown in box 32. The operating system provides a screen resolution as shown in box 34. The user sets the pressure and time for the jump 36. At this point, the program is ready to be used by a user.

The user then touches a location on the touchpad to which the cursor is to be moved and holds it with the required pressure and the required amount of time 38. When a user touches the touchpad 12 as in step 38, the program derives a single coordinate point 40. The program then translates this coordinate value from step 40 to a point on the screen where the cursor is set 42, and moves the cursor to this position 44. After step 44, the program resets ready for the next jump 46.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method of causing a mouse cursor in a computer system to jump from one point on a screen to another point on said screen, and wherein a mouse cursor is displayed on said screen, and a touchpad is operatively connected to said screen, comprising the steps of:
associating a coordinate system on said touchpad with a coordinate system on said screen to generate locations on said screen corresponding to given locations on said touchpad;
setting of pressure for a valid response from said touchpad to said screen at each coordinate location on the touchpad;
setting of the time for a valid response from said touchpad to said screen; and
determining a point with reference to a finger on said touchpad and, thus, an associated point on said screen for the movement of the mouse cursor to said associated point responsive to said set pressure and said set time on a given location on said touchpad.

2. The method of claim 1 wherein the touchpad is caused to reset after the mouse cursor on the screen has made its jump.

3. The invention as defined in claim 1 wherein the time setting is a minimum time.

4. The invention as defined in claim 3 wherein the time setting is about one second.

5. The invention as defined in claim 1 wherein the pressure setting is set to a high value.

6. The invention as defined in claim 1 wherein said cursor is moved to said associated point without being between said starting point and said associated point.

7. The invention as defined in claim 1 wherein said determined point on said touch pad is an average point.

8. A computer readable storage medium having computer program code stored therein, the program code comprising instructions which, when executed, causes a mouse cursor in a computer system to jump from one point on a screen to another point on said screen, and wherein a mouse cursor is displayed on said screen, and a touchpad is operatively connected to said screen, comprising the steps of:
associating a coordinate system on said touchpad with a coordinate system on said screen to generate locations on said screen corresponding to given locations on said touchpad;
pressure setting for a valid response from said touchpad to said screen at each coordinate location on the touchpad;
time setting for a valid response from said touchpad to said screen; and
determination of a point with reference to a finger on said touchpad and, thus, an associated point on said screen for the movement of the mouse cursor to said associated point and said associated point on said screen responsive to said set pressure and said set time on a given location on said touchpad.

9. A system comprising a computer with a screen and with a mouse cursor thereon, and a touchpad operatively connected to said screen;
circuitry which coordinates a system on said touchpad with a coordinate system on said screen to generate locations on said screen corresponding to given locations on said touchpad,
settings for the pressure for a valid response from said touchpad to said screen;
settings for the time for a valid response from said touchpad to said screen; and
said circuitry in said computer for the determination of a point with reference to a finger on said touchpad and, thus, an associated point on said screen for the movement of the mouse cursor to said associated point, said starting point on said screen responsive to said set pressure and said set time on a given location on said touchpad.

10. The invention as depicted in claim 9 wherein said circuitry is the code.

11. The computer system of claim 9 wherein the touchpad is caused to reset after the cursor on the screen has made its jump.

12. The computer system as defined in claim 9 wherein the time setting is about one second.

13. The invention as defined in claim 9 wherein the pressure setting is set to a high level.

14. The invention as defined in claim 9 wherein said cursor is moved to said associated point without being between said starting point and said associated point.

15. The invention as defined in claim 9 wherein said determined point on said touch pad is an average point.

16. The invention as defined in claim 9 wherein said cursor is moved to said associated point without being between said starting point and said associated point.

17. The invention as defined in claim 9 wherein said determined point on said touch pad is an average point.

18. A method comprising:
providing computer executable program code to be deployed to and executed on a computer system for:
causing a mouse cursor in a computer system to jump from one point on a screen to another point on said screen, and wherein a mouse cursor is displayed on said screen, and a touchpad is operatively connected to said screen, comprising the steps of:
associating a coordinate system on said touchpad with a coordinate system on said screen to generate locations on said screen corresponding to given locations on said touchpad;
setting pressure for a valid response from said touchpad to said screen at each coordinate location on the touchpad;
setting the time for a valid response from said touchpad to said screen; and
determining a point with reference to a finger on said touchpad and, thus, an associated point on said screen for the movement of the mouse cursor to said associated point responsive to said set pressure and said set time on a given location on said touchpad.

19. The invention as defined in claim 18 wherein said cursor is moved to said associated point without being between said starting point and said associated point.

20. The method of claim 18 wherein the touchpad is caused to reset after the mouse cursor on the screen has made its jump.
